(19) United States
(12) Patent Application Publication
(10) Pub. No.: US 2026/0278697 A1
(43) Pub. Date: Sep. 17, 2026

(54) AGRICULTURAL TRACKING SYSTEM WITH IMPROVED DATA ENTRY AND DATA ACCESS

(71) Applicant: Gevo, Inc., Englewood, CO (US)

(72) Inventor: Ronald Zink, Mercer Island, WA (US)

(21) Appl. No.: 19/080,277

(22) Filed: Mar. 14, 2025

(51) Int. Cl. G06Q 50/02; A01B 79/00; A01C 21/00; A01M 7/00

(52) U.S. Cl. CPC G06Q 50/02; A01B 79/005; A01C 21/005; A01M 7/0089

(57) ABSTRACT

A method includes setting a data template for growing a crop, the data template comprising an ordered plurality of agricultural machine passes with each agricultural machine pass having an associated operation. A designation that an agricultural field will be used to grow the crop is received and in response the data template is assigned to the agricultural field to form a database structure for the agricultural field. The database structure is then used to display a user interface showing that the ordered plurality of agricultural machine passes has been designated for the agricultural field.

### BACKGROUND

Modern agriculture utilizes complex systems to track numerous data points that affect the efficient production of crops. These systems include agricultural machines that perform actions on a field and collect and report data related to those actions as well as computers for storing and using such data.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes setting a data template for growing a crop, the data template comprising an ordered plurality of agricultural machine passes with each agricultural machine pass having an associated operation. A designation that an agricultural field will be used to grow the crop is received and in response the data template is assigned to the agricultural field to form a database structure for the agricultural field. The database structure is then used to display a user interface showing that the ordered plurality of agricultural machine passes has been designated for the agricultural field.

In accordance with a further embodiment, a method includes displaying entries for a plurality of agricultural machine passes for a plurality of agricultural fields on a single screen and providing a control that allows a user to approve data for a single agricultural machine pass for at least two of the plurality of agricultural fields. An indication that the user has invoked the control is received and in response, indications are stored in a database that the data has been approved for the single agricultural machine pass for each of the at least two of the plurality of agricultural fields.

In accordance with a still further embodiment, a method includes displaying parameters for a plurality of agricultural machine passes for each of a plurality of agricultural fields on a single screen and providing a control in association with a displayed parameter to view evidence for the parameter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system used to perform various embodiments.

FIG. 2 is a flow diagram of creating and using templates for agricultural fields that grow a select crop.

FIG. 3 is an example user interface for entering grower information.

FIG. 4 is an example user interface for entering general information for a farm.

FIG. 5 is an example user interface for entering general information for growing crops on a farm.

FIG. 6 is a flow diagram of a method of creating a template for a crop.

FIG. 7 is an example of a user interface for adding a pass to a template.

FIG. 8 is an example of a user interface for defining a pass in a template for a crop.

FIG. 9 is an example of a user interface showing a data ingestion screen before fields have been assigned crops.

FIG. 10 is an example user interface for entering information for a field.

FIG. 11 is an example of a user interface showing a data ingestion screen after passes have automatically been added to fields after the fields have been assigned crops.

FIG. 12 is an example user interface for setting parameters for a pass for a field.

FIG. 13 is an example of an attestation screen for attesting to the parameters set in FIG. 12.

FIG. 14 is an example user interface that allows a grower to upload evidence of parameters provided for a pass of a field.

FIG. 15 is a flow diagram of a method for approving data for a pass entry.

FIG. 16 is an example user interface providing a control for approving data for a pass entry.

FIG. 17 is a flow diagram of a method of evaluating the status of an entry.

FIG. 18 is an error screen for missing data in the entry.

FIG. 19 is an error screen for multiple sets of data being assigned to the same pass entry.

FIG. 20 is an attestation screen for attesting to a pass not being performed for an agricultural field.

FIG. 21 is a flow diagram of a method of providing a control for approving data across a plurality of agricultural fields.

FIG. 22 is an example of a user interface providing a control for approving data across a plurality of agricultural fields.

FIG. 23 is a flow diagram of a method of providing a control for approving data for a plurality of agricultural machine passes for an agricultural field.

FIG. 24 is an example of a user interface providing a control for approving data for a plurality of agricultural machine passes.

FIG. 25 is an example of a user interface showing a control for requesting evidence of an agricultural machine pass’s data.

FIG. 26 is an example of a user interface showing a pop-up window showing evidence of an agricultural machine pass’s data.

### DETAILED DESCRIPTION

While technology for agricultural operations has improved, it still places a considerable burden on growers. In particular, current systems used to determine sustainability values for a crop require the grower to identify characteristics of treatments applied to the crop’s field. In addition, current systems do not provide a means for displaying documents that establish that a particular treatment was performed on a field during a particular pass of an agricultural machine across a field. As a result, verifying that a sustainability value for a crop is accurate is time consuming and often impractical.

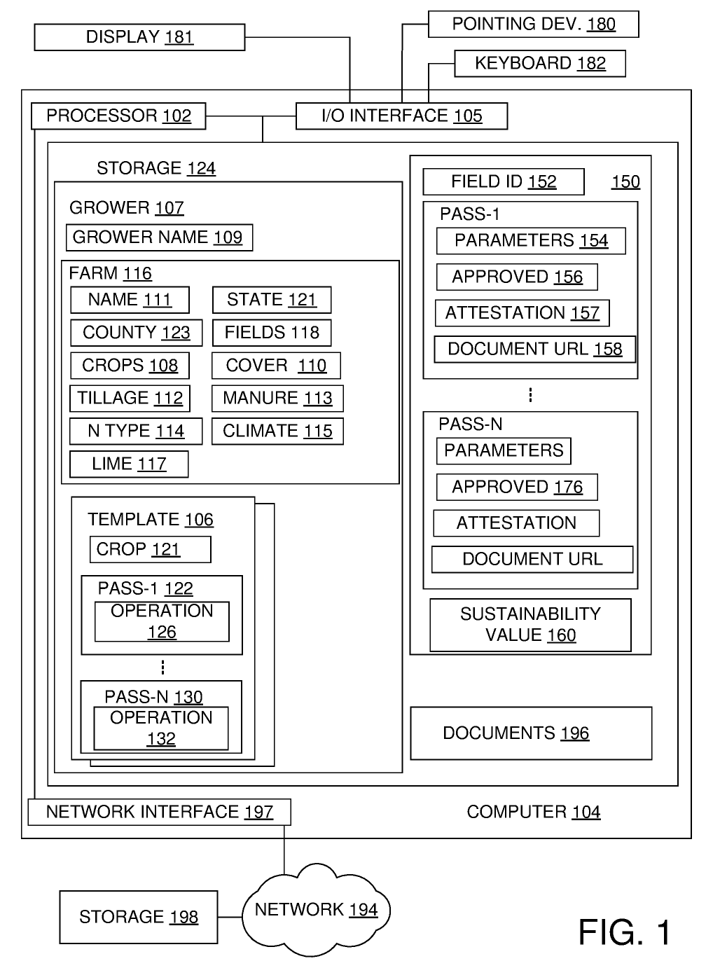

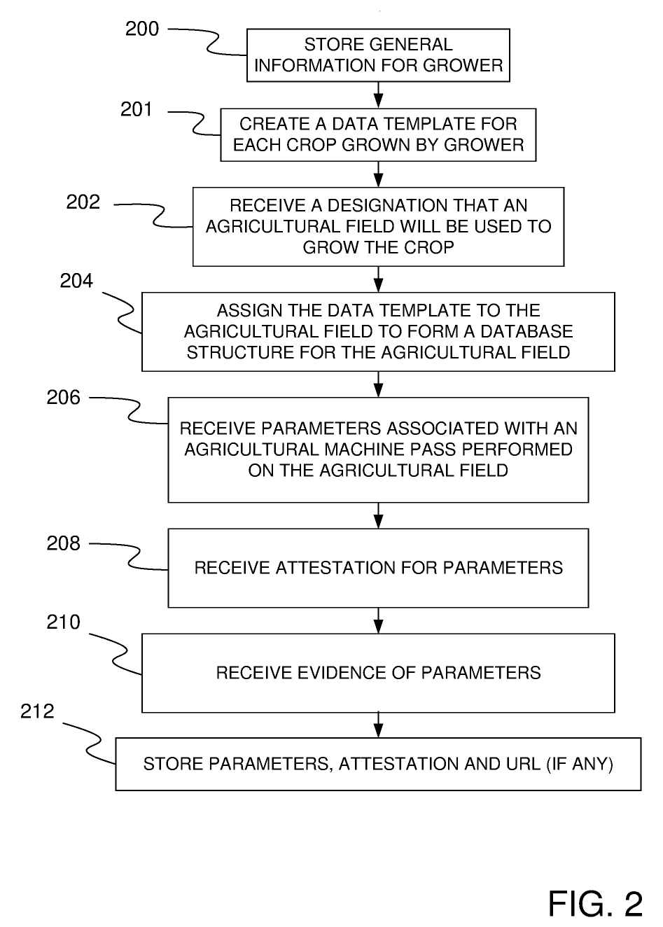

FIG. 1 provides a block diagram of a system 100 used to implement the various embodiments described below. FIG. 2 provides a flow diagram of an embodiment in which system 100 is used to easily enter information needed to determine a sustainability value.

System 100 depicts a desktop computing device having a computer 104, a display 181, a pointing device such as a mouse 180, and a keyboard 182. Computer 104 is in communication with a network 194 such that computer 104 may store values in a remote storage/remote computer 198 and such that computer 104 may communicate with remote computers. Although system 100 depicts a desktop computer, the embodiments described below are not limited to being performed on a desktop computer and may be performed on any computing device including laptops, tablet devices and smart phones. In such embodiments, display 181 has a touch-sensitive screen. Keyboard 182, pointing device 180, and touch-sensitive display 181 are referred to generically as input devices.

In step 200 of FIG. 2, system 100 requests and stores general information about a grower. In accordance with one embodiment, this information is requested using a user interface displayed on display 181 through an interface 105. A user can use one or more of the input devices to provide values requested in the user interface.

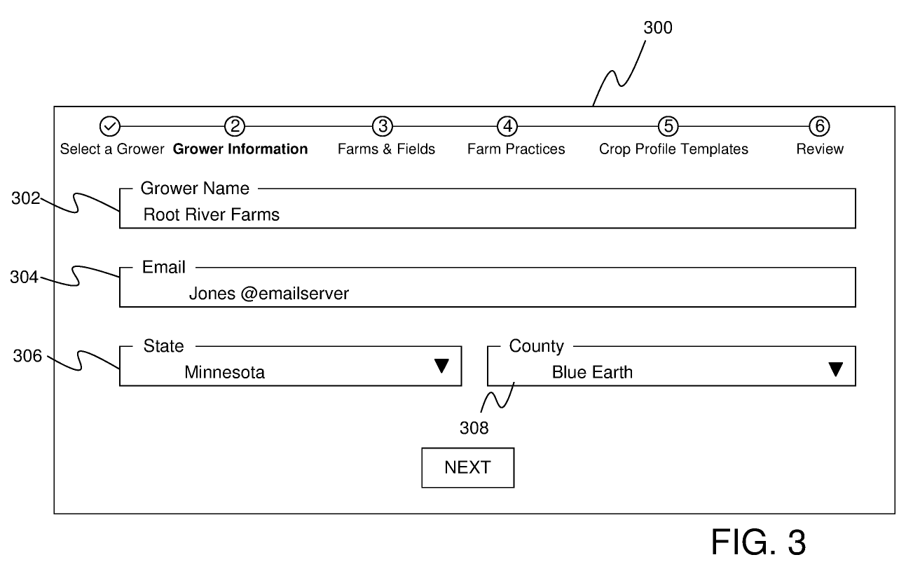

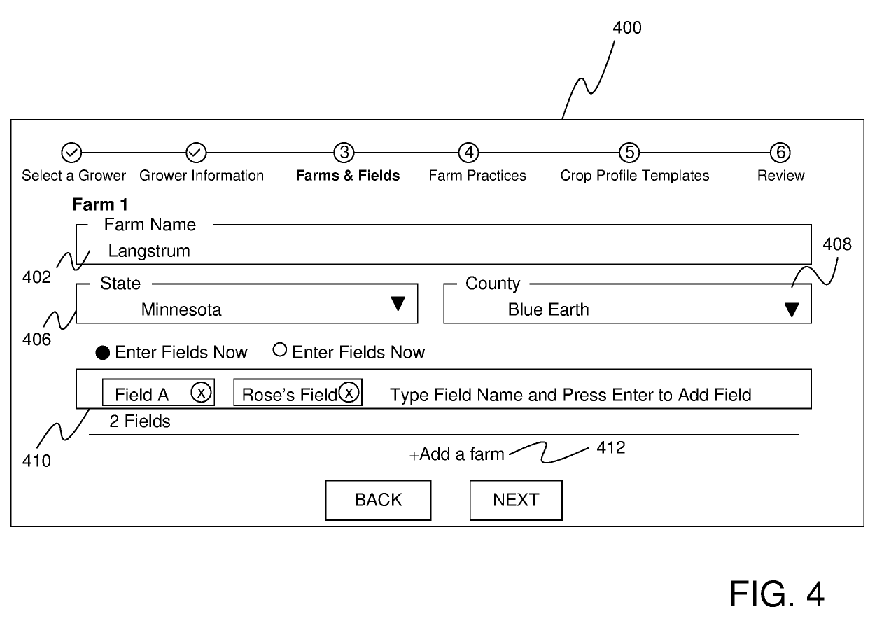

In accordance with one embodiment, step 200 includes providing a user interface 300 of FIG. 3, which requests the grower’s name in input box 302, an email address in input box 304, a state and county in input boxes 306 and 308 for the grower’s offices. Step 200 further includes providing user interface 400 of FIG. 4, which requests information for the farms operated by the grower. This information includes the farm’s name 402, the state 406 and county 408 where the farm is located, and a field list 410. Field list 410 includes one or more fields that constitute the farm. The same type of information shown in FIG. 4 can be provide for other farms operated by the grower by using “+Add a farm” control 412, which will cause the same input boxes to be displayed for another farm field.

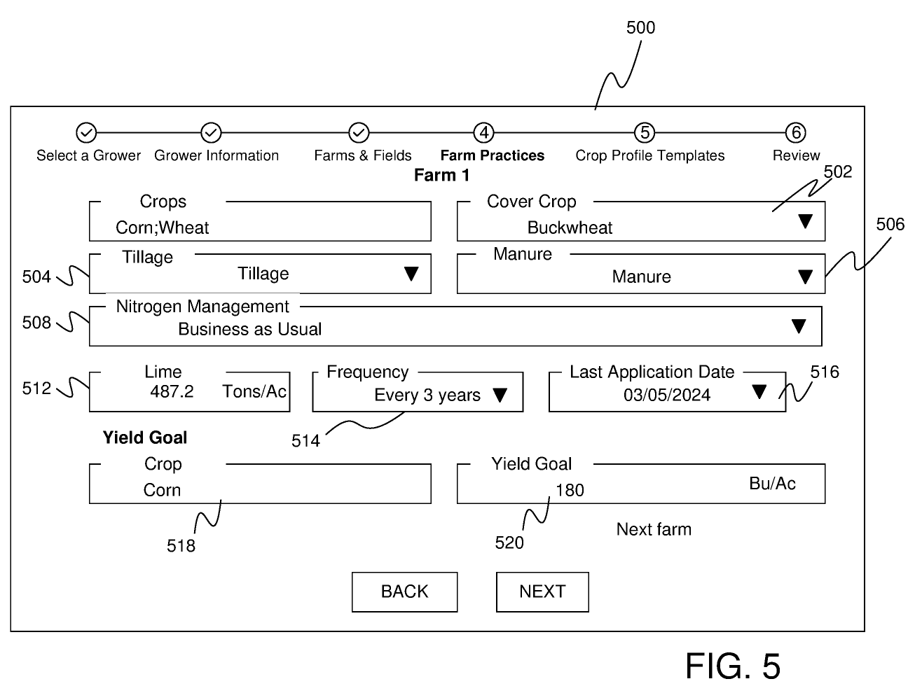

Step 200 further includes receiving farm practice information using user interface 500 of FIG. 5. The farm practice information describes practices that are common to all fields that constitute the farm and include cover crop 502, tillage type 504, manure type 506, nitrogen application type 508, lime application rate 512, lime application frequency 514, date of last lime application 516, yield goal crop 518 and yield goal 520. For cover crop input 502, the grower can select the cover crops they use on the farm or that they do not use a cover crop. For tillage type input 504, the grower can select conventional tillage, reduced tillage or no till. For manure type 506, the grower can select the type of manure applied to the farm’s fields or can select that no manure is applied to the fields. For nitrogen type input 508, the grower can specify whether they use a standard nitrogen application or use enhanced efficiency fertilizer that reduces fertilizer-induced nitrogen oxide emissions. In input boxes 512 and 514, the grower indicates the rate and frequency of lime application and in box 516, the last date on which lime was applied to the field. In yield goal crop box 518 and yield goal 520, the grower can provide a list of crops and corresponding yield goals for each crop.

The general information received in step 200 is stored in memory storage 124 of computer 104 by processor 102. In particular, the information from user interfaces 300, 400 and 500 are stored in grower data structure 107, which includes a grower name 109 and farm entries 116. Each farm entry 116 includes details for a farm associated with the grower including a farm name 111, state 121, county 123, field list 118, crops 108, cover crop 110, tillage 112, manure 113, nitrogen type 114, climate 115 and lime 117

At step 201 of FIG. 2, a respective data template 106 is created for one or more of the crops grown by the grower. Each template consists of a sequence of passes, where each pass is the movement of an agricultural machine across the field to perform an action within the field, such as planting, fertilizing, applying an insecticide, applying a herbicide and harvesting, for example.

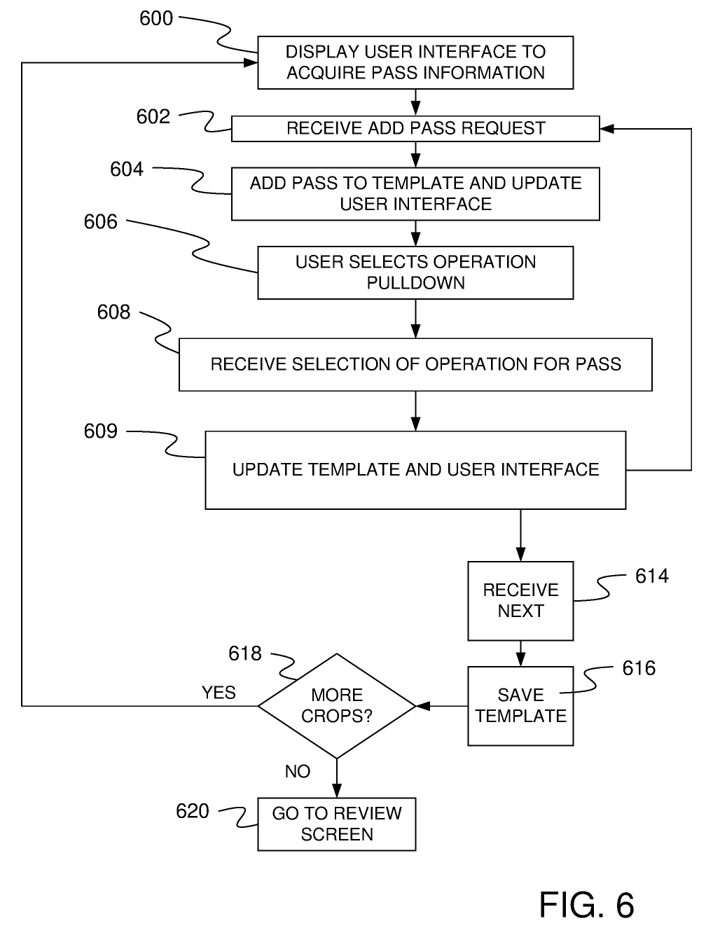

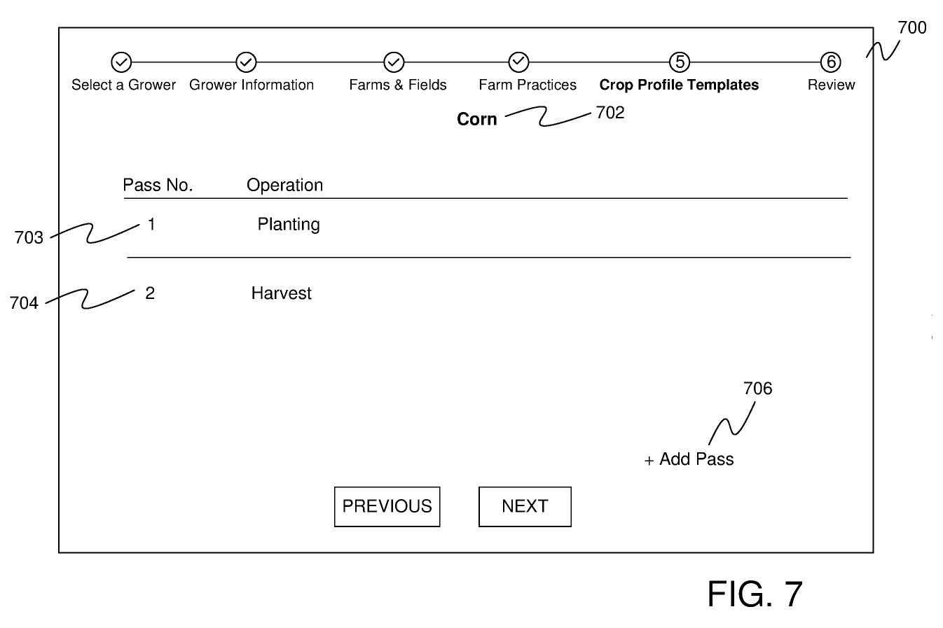

FIG. 6 provides a method for creating a data template 106. At step 600, a user interface is displayed to acquire pass information for growing a crop. An example of such a user interface is shown as user interface 700 of FIG. 7. In user interface 700, a crop designation 702 is provided together with a required planting pass 703 and a required harvest pass 704, which must be in each template.

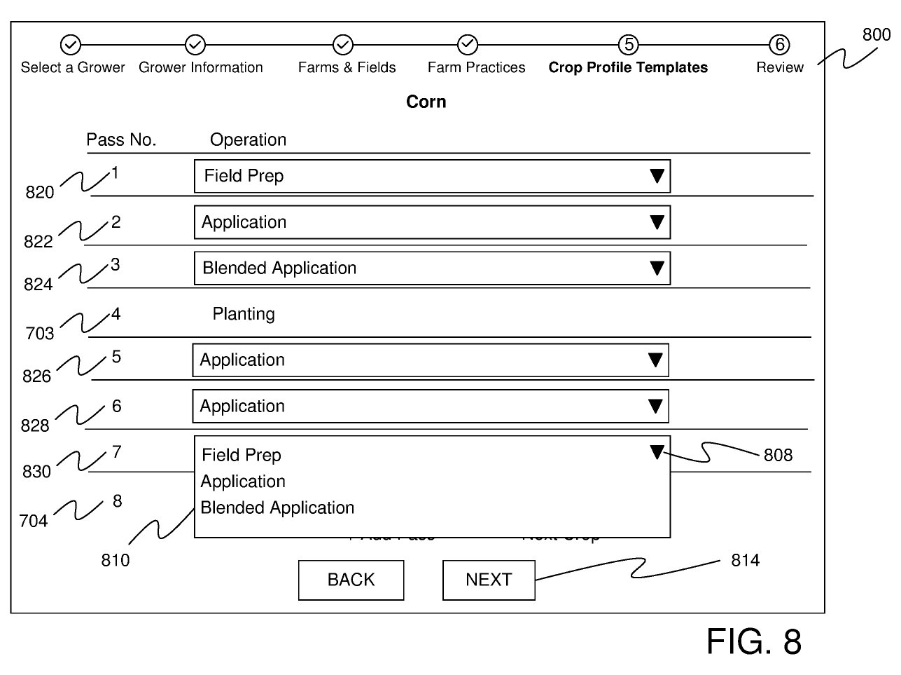

At step 602, an Add Pass request is received when a user selects +Add Pass control 706 in user interface 700. In response, system 100 adds a pass to the template and updates the user interface at step 604 to produce user interface 800 of FIG. 8. In user interface 800, passes 802, 822, 824, 826, 828, and 830 have been added such that planting pass 703 is the fourth pass that will performed and harvest pass 704 is the eighth pass that will be performed.

User interface 800 shows pass 830 with an operation pulldown 808. At step 606 of FIG. 6, the user activates pulldown 808 to display a list 810 of possible operations that can be performed on the field. Examples of possible operations include field preparation, application of a single product such as pesticide, fungicide, insecticide, and fertilizer, and application of a blend of multiple products such as two or more of those listed above. At step 608, computer 104 receives a selection of an operation for the pass from an input device and updates the template and user interface based on the selected operation.

Additional passes are added by the user through additional activations of +Add Pass control at step 602. When the user has added all of the desired passes for the crop, the user can select Next control 814 at step 614. When Next control 814 is selected, the current template is saved at step 616 and processor 102 determines if there are more crops designated for the farm at step 618. If there are more crops, a user interface for acquiring pass information for a template for another crop is displayed by returning to step 600. Steps 602-616 are then performed for the new crop to form a template for the new crop. When there are no other crops designated for the farm, the template formation process of FIG. 6 is completed and a review screen is displayed at step 620.

Saving a template at step 616 involves storing a template 106 in storage 124 where template 106 includes a crop designation 121 and a list 123 of passes such as passes 122 and 130 that each have a designated operation such as operations 126 and 132.

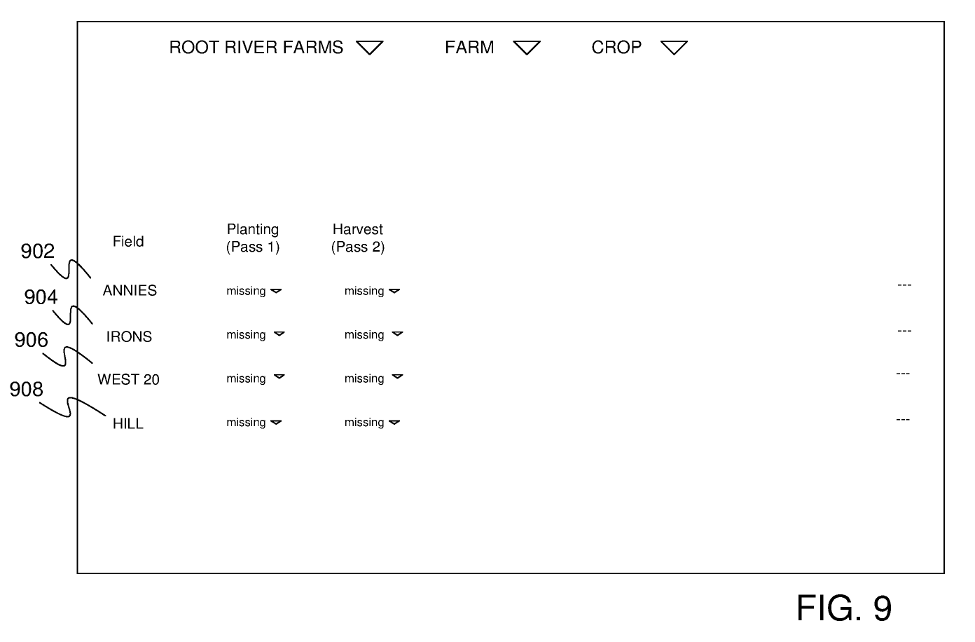

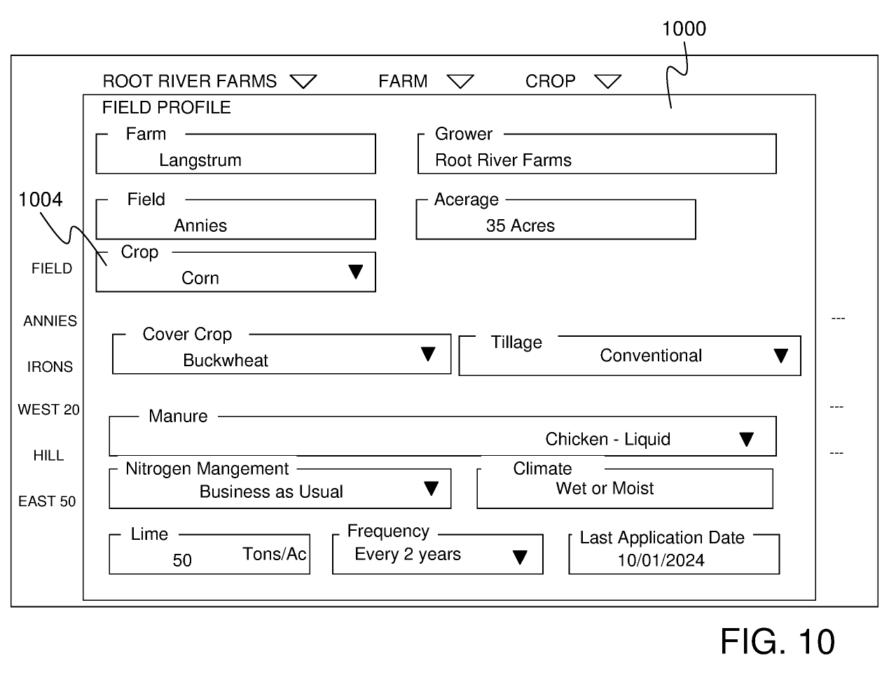

Returning to FIG. 2, after setting a data template for crops at step 201, a designation that an agricultural field will be used to grow a particular crop is received at step 202. FIG. 9 provides an example data ingestion user interface 900 that shows the agricultural machine passes assigned to four fields 902, 904, 906, and 908 before a crop has been designated for the four fields. To designate a crop for the field, a field profile window is opened by clicking on the name of the field in user interface 900. FIG. 10 provides an example of a window 1000 that is opened when name entry 902 is selected.

In FIG. 10, window 1000 includes a crop input box 1004 that the grower fills with the crop that is to be grown in the field to thereby perform designation step 202 of FIG. 2.

In response to receiving the designation that an agricultural field will be used to grow the crop, processor 102 of computer 104 assigns the data template associated with the crop to the to the agricultural field to form a database structure for the agricultural field at step 204. For example, in FIG. 1, processor 102 creates a database structure 150 that includes field ID 152, which can be the field name or a combination of the farm and field name as well as a list of agricultural machine passes associated with the template for the crop assigned to the field. For example, in data structure 150, pass 1 of template 106 to pass N 130 of template 106 have been added to data structure 150. For each agricultural pass, the data structure includes parameters for the pass, such as parameters 154, an indication 156 of whether the parameters or lack of parameters for the pass have been accepted by the grower, an attestation 157 that the parameters of the pass are correct and a document URL 158 that indicates the location of a document that provides proof of parameters 154. In accordance with one embodiment, data structure 150 also includes a sustainability value 160 calculated for the field after parameters or lack of parameters for the passes have been accepted by the grower.

Returning to FIG. 2, once the data structure has been created, it can be used to receive and store data indicating parameters associated with an agricultural machine pass performed on the agricultural field at step 206.

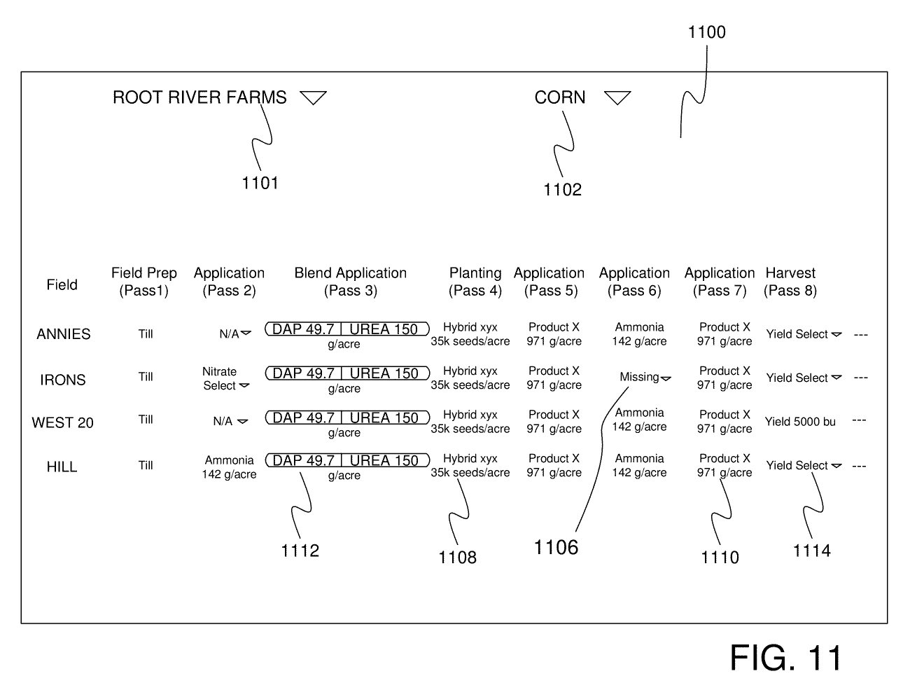

FIG. 11 provides a data ingestion user interface 1100 that shows the status of data associated with each agricultural machine pass assigned to a collection of fields. In FIG. 11, the Root River Farms fields that have been designated as growing corn are displayed based on the selection of Root River Farms in entry 1101 and the selection of corn in entry 1102. For each agricultural machine pass of each field, there is an entry that contains the status of the data for that agricultural machine pass. If no data has been provided, such as in entry 1106, the status is set to “missing” and a pulldown control is provided for manually entering the data. If a user has already indicated that no data will be provided for the entry, the entry shows “N/A”. If data has been received for the agricultural pass, information about the operation performed during the pass is shown in the entry. For example, in entry 1108, the type of corn that was planted and the number of seeds per acre that were planted in the Hill field is shown and in entry 1110, the name of a product (Product X) that was applied during pass 7 and the number of grams/acre that were applied during the pass is shown. For blended application passes, such as entry 1112, the name and amount of each product that was applied during the pass is shown. When conflicting information has been provided for an entry, such as two different products being assigned to the same entry or two different amounts being assigned to the same entry, the entry will include the word “select” and a pull down control that the user can use to select the correct value for the entry. Entry 1114 provides an example of an entry having a “select” control.

For most agricultural machine passes, the data received at step 206 is received from the agricultural machine used to perform the pass. For application passes and blended application passes, this data includes the identities of the products applied during the pass and the amount of each product applied per acre during the pass. The amount of each product may be entered into the agricultural machine or may be measured by the agricultural machine during the pass. For planting passes, the data includes the identity of the seed that is being planted and the number of seeds per acre that are planted. The number of sets can be entered into the agricultural machine or can be measured by the agricultural machine. For harvest passes, the data is the number of bushels per acre.

In accordance with one embodiment, the agricultural machine provides a machine identifier that uniquely identifies the agricultural machine as well as location information and date/time stamps with the pass data. The location information can include the field name used by the farmer or geographic coordinates where the pass took place. The date/time stamps indicate when the pass took place.

The information provided by the agricultural machine is typically provided to a server which exposes one or more APIs for acquiring the information. Computer 104 calls the appropriate API to acquire pass data for each field from the server.

Once computer 104 has pass data for a field, computer 104 must assign the data to an agricultural pass defined for the field. For application data, computer 104 assigns the data by first determining whether planting has occurred in the field. If planting has not occurred, only application and blended application passes that precede planting in the template are considered candidates for the pass data. If planting has occurred, only application and blended application passes that follow planting in the template are considered candidates for the pass data.

Next, if the pass data indicates that multiple products were applied and at least one blended application pass is still considered a candidate pass, each candidate blended application pass remains a candidate and candidate passes that are not blended application passes are removed from consideration. If there is only a single candidate blended application pass, the data is assigned to the single candidate blended application pass. If there are multiple blended application passes, the pass data may be assigned to one of the candidate blended application passes based on the date of the application and/or based on a prior year’s application data for the field. Alternatively, the pass data can be assigned to all of the candidate blended application passes.

If the pass data indicates that only a single product was applied and there are multiple candidate application passes or multiple candidate blended application passes or one candidate application pass and one candidate blended application pass, the pass data may be assigned to one of the candidate application passes or blended application passes based on the date of the application and/or based on a prior year’s application data for the field. Alternatively, the pass data can be assigned to all of the candidate application passes and candidate blended application passes.

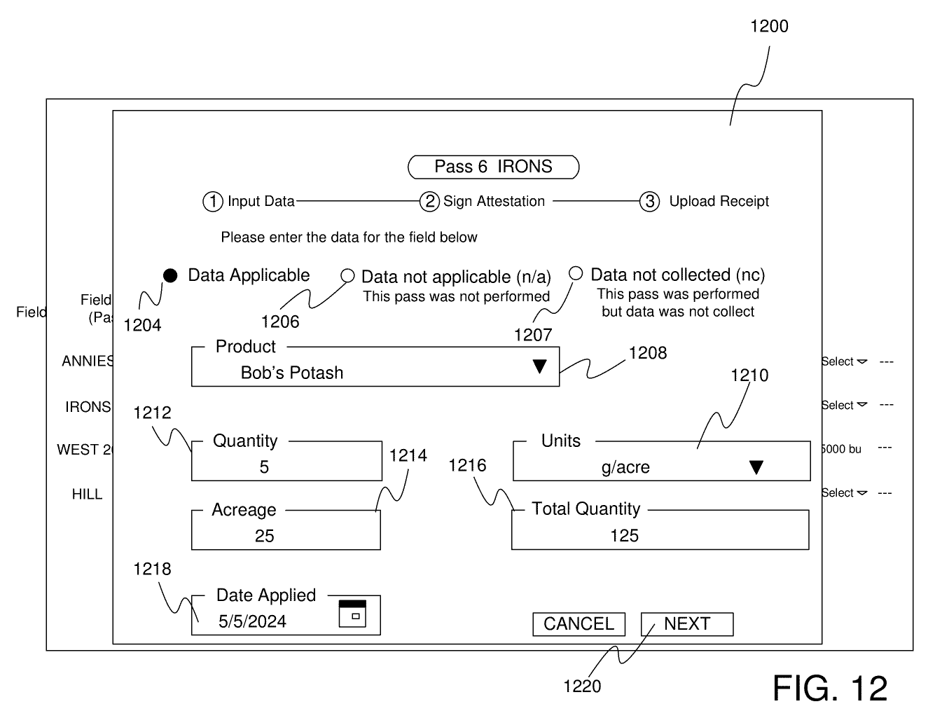

Data for a pass for a field can also be entered manually. To manually add the data, the entry for the pass is selected. In response, a data input user interface, such as user interface 1200 of FIG. 12, is displayed.

User interface 1200 includes radio buttons 1204, 1206 and 1207 that can be used to indicate whether data will be provided for the pass for this field. Radio button 1206 is selected when the pass will not be performed for the field such as when weather prevents an application from being applied. Radio button 1207 is selected when a pass was performed but data for the pass was not collected. When radio button 1207 is selected, computer applications that require the data, such as sustainability calculators, will use default values for the application or will average sustainability values determined for other fields. When radio button 1204 is selected, data will be provided for this pass for this field.

User interface 1200 also includes a product input box 1208 that receives the name of the product that will be applied during the pass. A list of possible products is displayed in response to selection of a pull down control within input box 1208. In accordance with one embodiment, only products within the list of possible products may be selected.

The grower then indicates the unit of measure for the product in input box 1210 and the amount of the product in input box Computer 104 calculates the total quantity 1216 of product applied based on the acreage 1214 of the field, which has been previously entered for the field. The date the product was applied is provided in input box 1218.

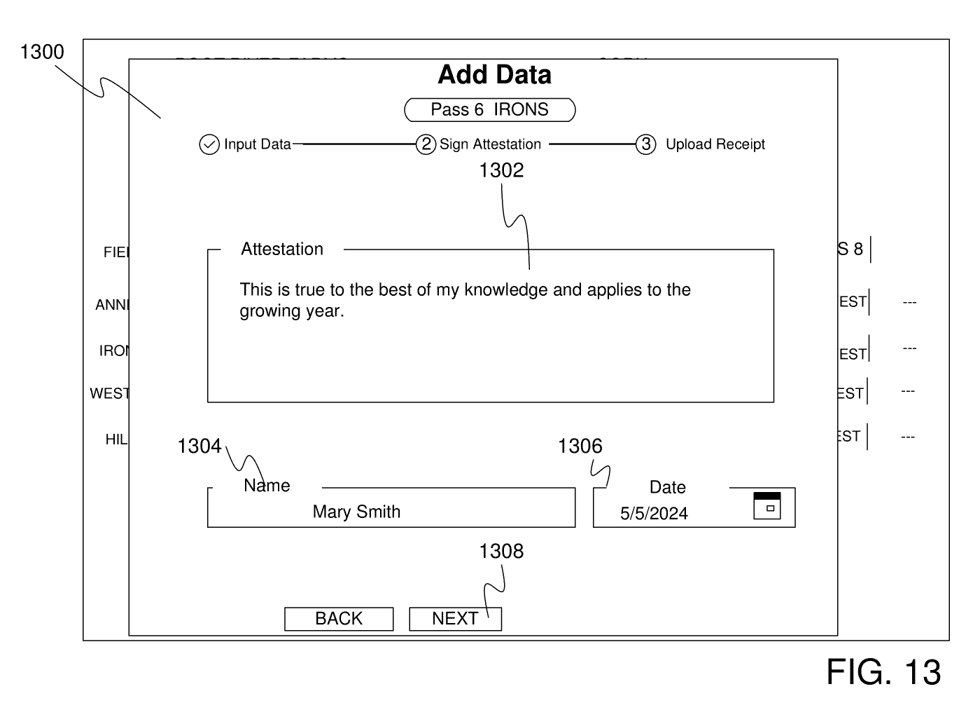

When the grower selects Next control 1220, an attestation user interface 1300 of FIG. 13 is displayed that receives an attestation from the grower at step 208. Attestation user interface 1300 includes attestation text 1302, name input 1304 and date input 1306. Attestation text 1302 provides an attestation that the parameters entered in user interface 1200 accurately describe what occurred during the pass. Name input 1304 receives the name of the person entering the parameters of the pass and date input 1306 receives the date on which the attestation was made.

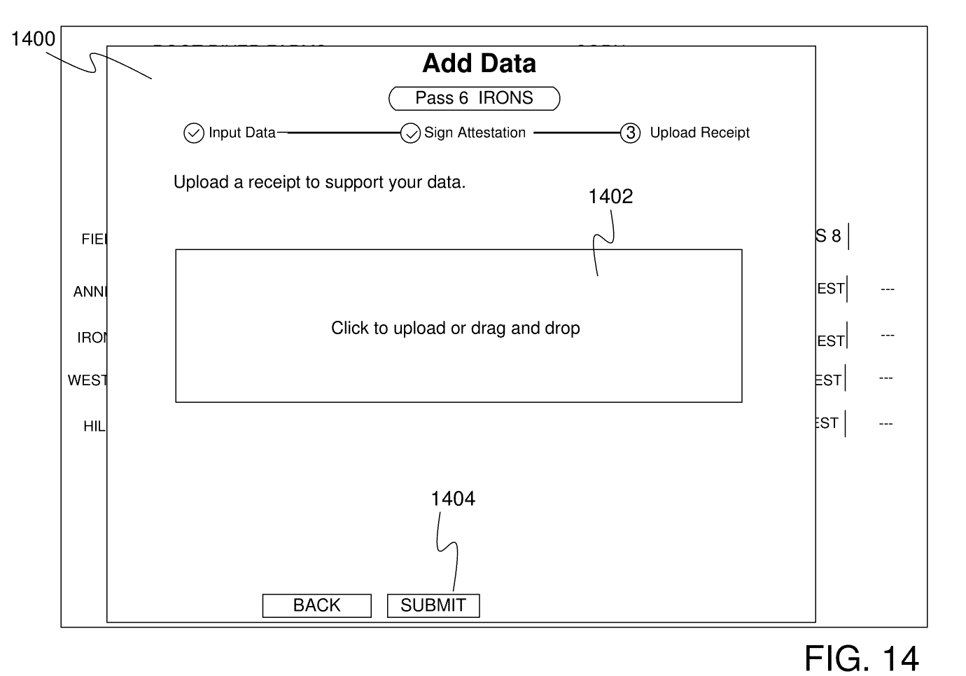

When the grower selects Next control 1308, a receipt user interface 1400 of FIG. 14 is displayed that receives evidence of the parameters at step 210. The evidence can include a document or image showing the parameters of the pass such as a receipt for the product or an image of the product container. The document or image is uploaded using control box 1402. Such uploading can include making a copy of the document and image and storing the copy in a dedicated storage area or simply recording the Uniform Resource Locator of the document or image.

When the grower selects submit control 1404, the pass parameters, the attestation and the URL of the evidence of the parameters are stored in data storage 124 at step 212. For example parameters 154, attestation 157 and document URL 158 are stored for pass-1 in FIG. 1.

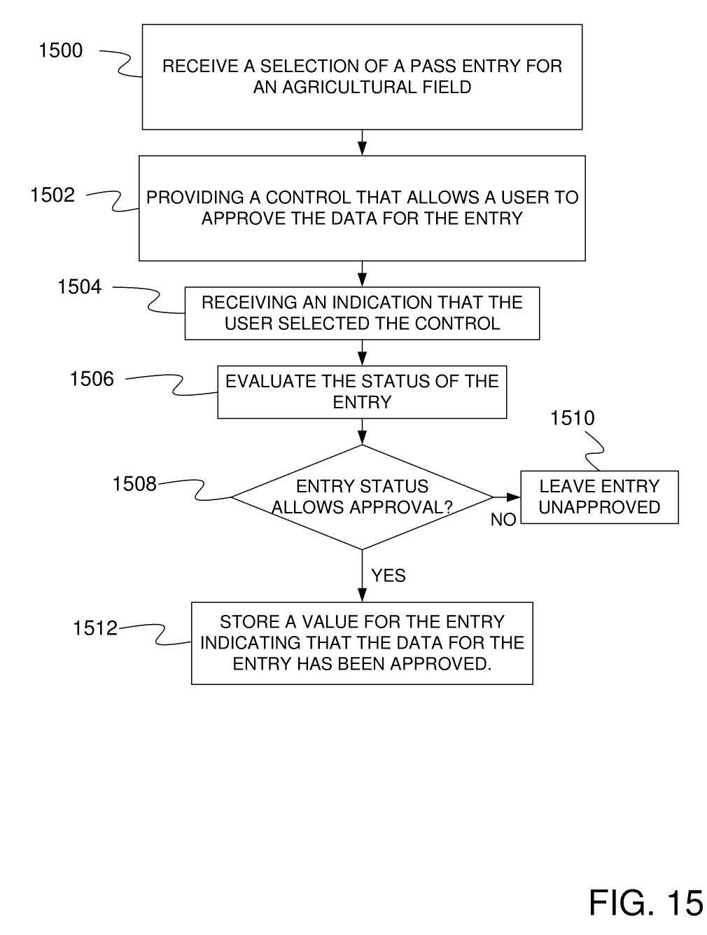

To ensure that the data for each pass for each field is correct, the present embodiments provide approval controls that allow a grower to indicate that the data assigned to a pass for a field is correct. FIG. 15 provides a flow diagram of a method for providing and utilizing an approval control for a single entry.

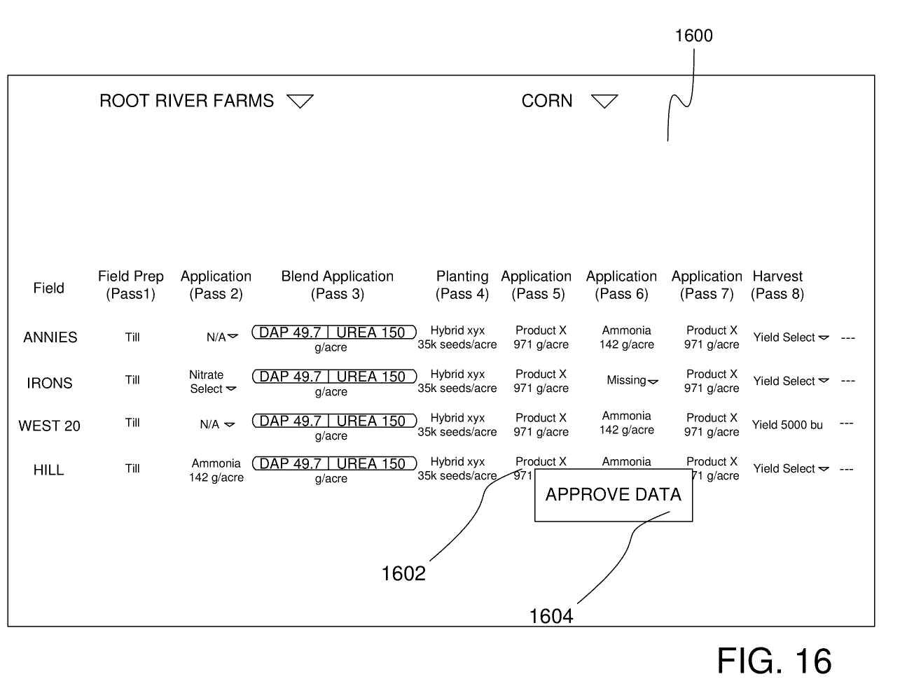

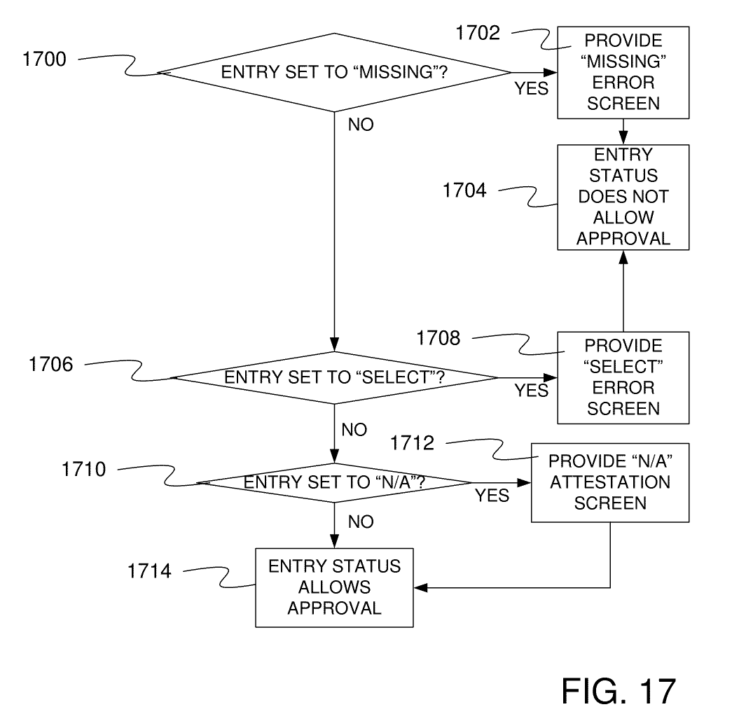

In step 1500, a selection of a pass entry, such as entry 1602 of FIG. 16, is received. In response, at step 1502, computer 104 provides an approval control 1604 on the screen. At step 1504, the selection of the approval control is received and in response the status of the entry is evaluated at step 1506. FIG. 17 provides a flow diagram of a method of evaluating the status of the entry.

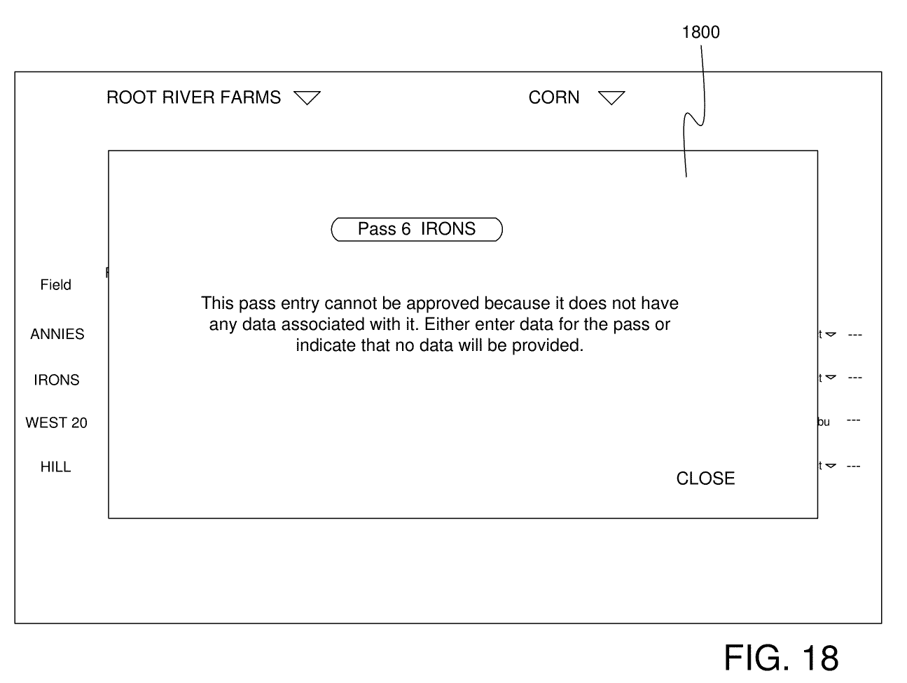

In step 1700 of FIG. 17, the method determines if the entry status is set to “missing.” If the entry status is set to “missing”, no data has been provided for the entry. In response, at step 1702, computer 104 displays a “missing” error screen. An example of a “missing” error screen 1800 is shown in FIG. 18. “Missing” error screen 1800 conveys that data must be provided for the entry or, in the alternative, the grower must indicate that no data will be provided for the entry. Because the entry status is set to “missing,” the entry status does not allow the entry to be approved as indicated by step 1704.

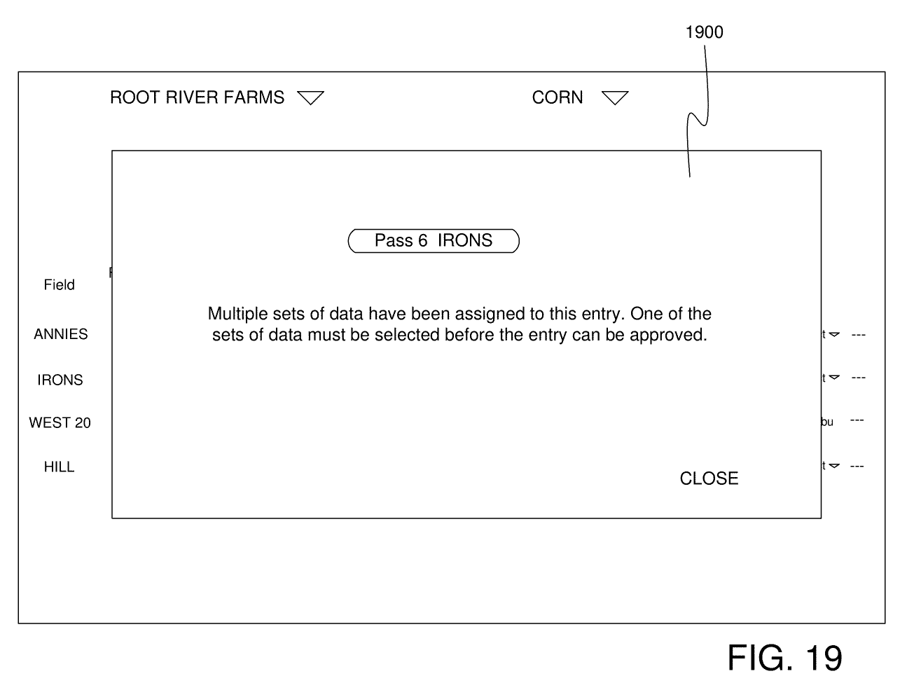

When the entry status is not set to “missing” at step 1700, the method determines if the entry status is set to “select” at step 1706. When the entry status is set to “select”, more than one set of data values have been assigned to the entry and it is not clear which set of data values is the correct set of data values. This can occur when pass data is provided by multiple agricultural machines for the same entry or when both manually entered data and agricultural machine data are received for the same entry. In response to the entry status being set to “select,” a “select” error screen, such as error screen 1900 of FIG. 19, is displayed at step 1708. The “select” error screen indicates that more than one set of data has been assigned to the entry and the grower must select one of sets of data before the entry can be approved. Because the entry status is set to “select,” the entry status does not allow the entry to be approved as indicated by step 1704.

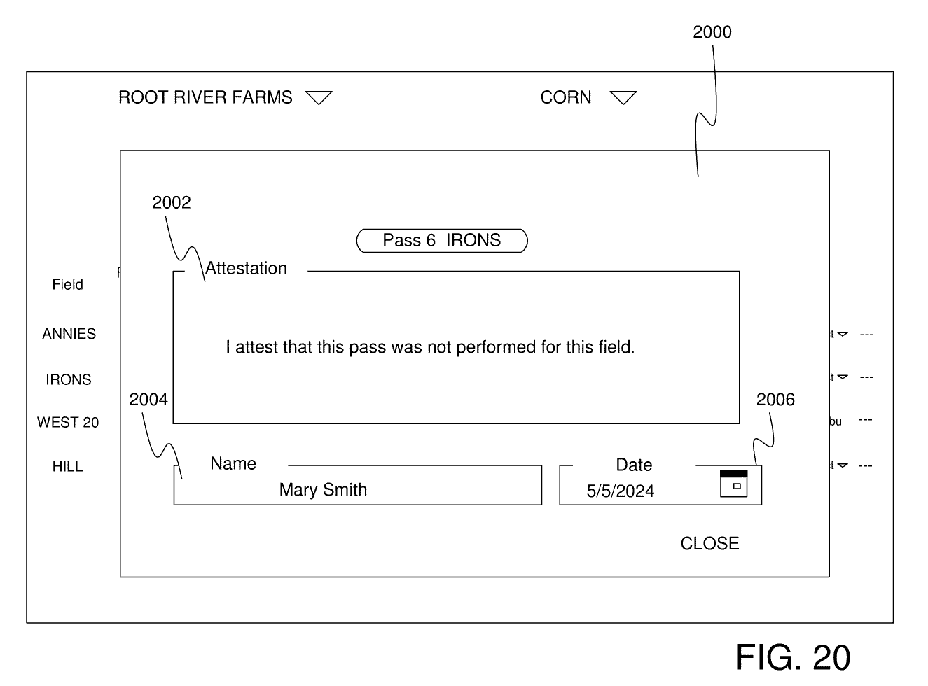

When the status of the entry is not “select” at step 1706, the method determines if the entry status is set to “N/A.” When the status is “N/A” an attestation is needed that no data will be provided for the entry. At step 1712 an “N/A” attestation screen, such as attestation screen 2000 of FIG. 20, is displayed. The attestation screen includes an attestation 2002, a name input 2004 for the name of the person making the attestation, and a date box 2006 for the date on which the attestation is being made.

After the attestation has been made at step 1712 or when the entry status is not “N/A” at step 1720, the entry status allows the entry to be approved at step 1714.

Returning to FIG. 15, after the entry status has been evaluated, the method determines if the entry status allows the entry to be approved at step 1508. When the entry status does not allow the entry to be approved, the entry is left unapproved at step 1510. When the entry status allows the entry to be approved, a value is stored for the entry indicating that the data for the entry or lack of data for the entry has been approved at step 1512. For example, in FIG. 1, APPROVED values 156 and 176 indicate whether the data for an entry has been approved.

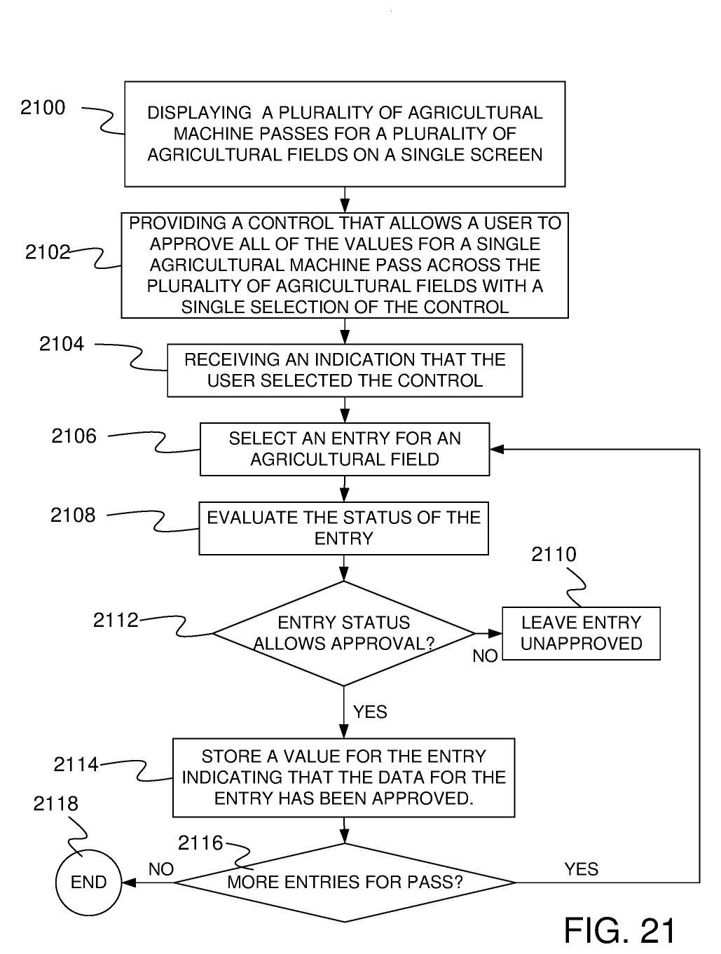

In addition to providing controls for approving a single entry, further embodiments provide a single control for approving the entries for a single machine pass across a plurality of fields. FIG. 21 provides a method of using such an approval control.

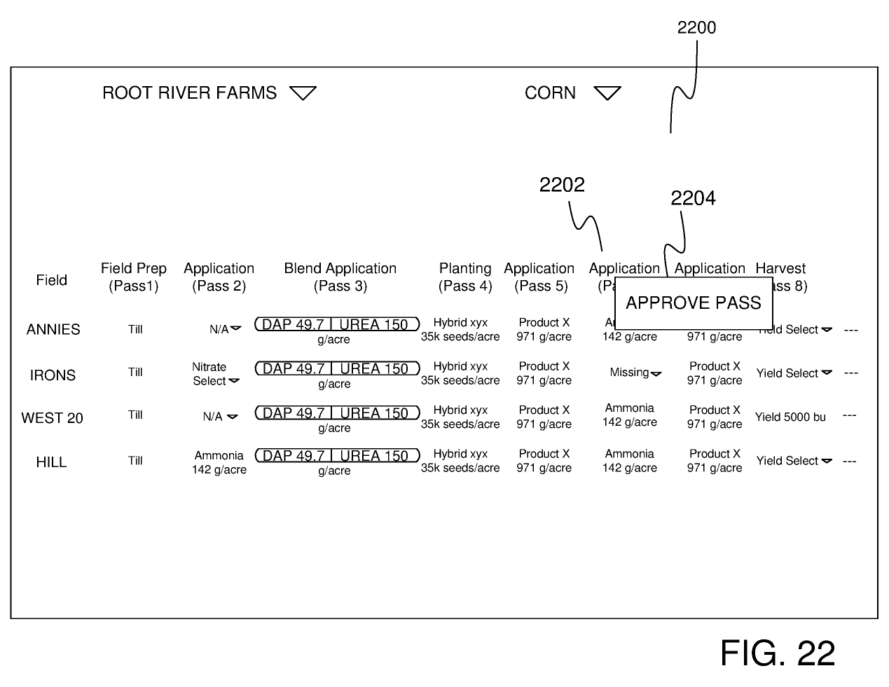

In step 2100 of FIG. 21, a plurality of agricultural machine passes are displayed for a plurality of agricultural fields on a single screen as shown in user interface 2200 of FIG. 22. At step 2102, the user selects a machine pass header, such as machine pass header 2202 and in response a pass approval control 2204 is provided that allows a user to approve the data for every pass entry for the agricultural machine pass with a single selection of pass approval control 2204.

At step 2104, processor 102 receives an indication that the user has selected control 2204 using one of the input devices. In response, at step 2106, processor 102 selects one of the entries for the pass.

The status of the selected entry is evaluated at step 2108 using the process of FIG. 17. After the entry status has been evaluated, the method determines if the entry status allows the entry to be approved at step 2112. When the entry status does not allow the entry to be approved, the entry is left unapproved at step 2110. When the entry status allows the entry to be approved, a value is stored for the entry indicating that the data for the entry or lack of data for the entry has been approved at step 2114.

At step 2116, the method determines if there are more entries for the pass. If there are more entries, the method returns to step 2106 to select the next pass entry and steps 2108-2114 are repeated for the next pass entry. When all of the pass entries have been processed, the method of FIG. 21 ends at step 2118.

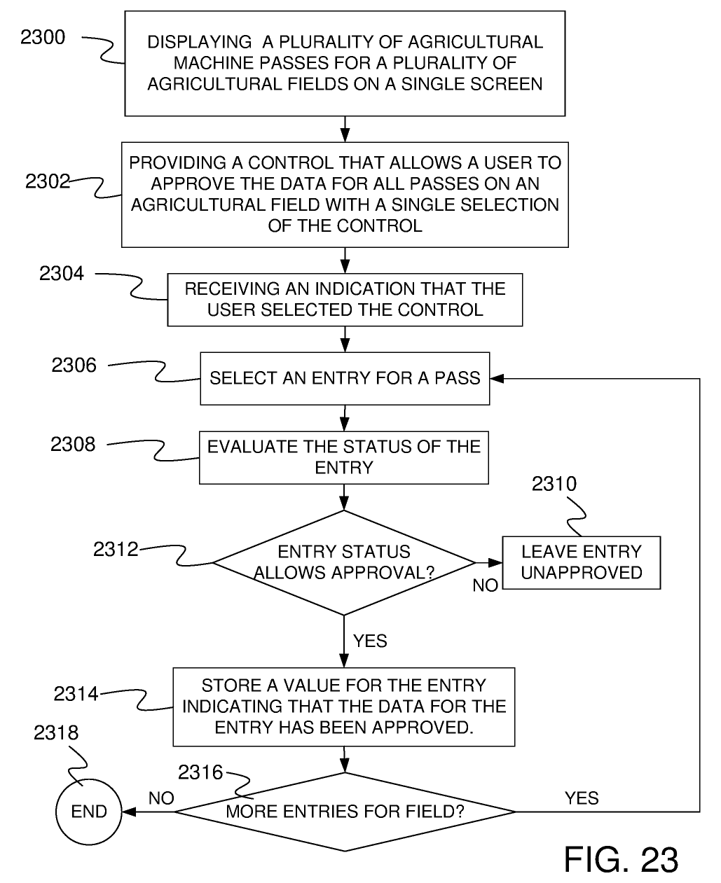

Further embodiments provide a single control for approving the entries for all of the passes of a single agricultural field. FIG. 23 provides a method of using such an approval control.

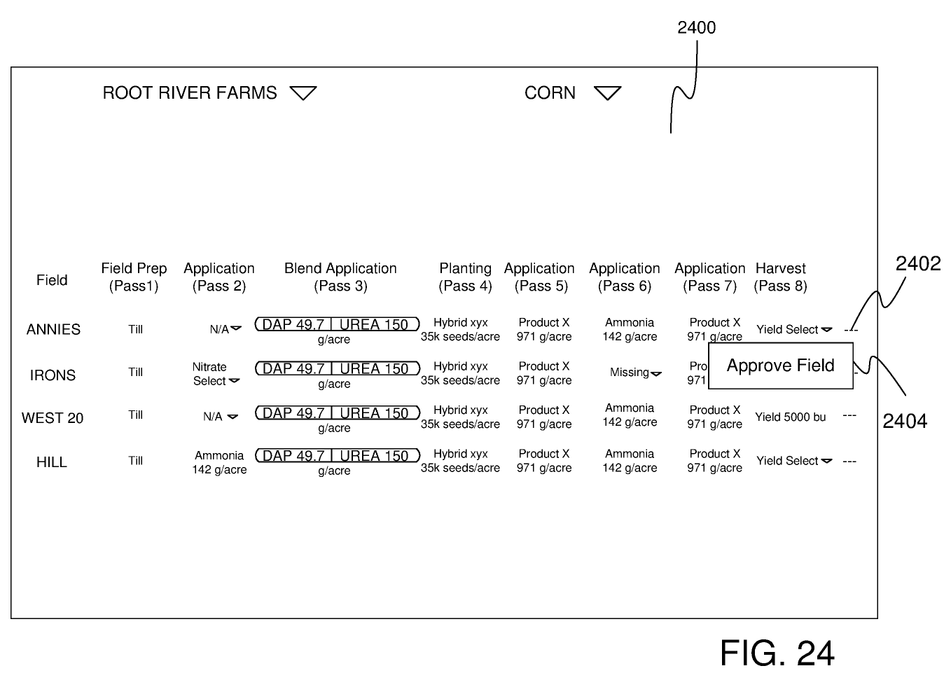

In step 2300 of FIG. 23, a plurality of agricultural machine passes are displayed for a plurality of agricultural fields on a single screen as shown in user interface 2400 of FIG. 24. At step 2302, the user selects an agricultural field menu control, such as menu control 2402 for ANNIES field, and in response a field approval control 2404 is provided that allows a user to approve the data for every pass for the selected agricultural field with a single selection of field approval control 2404.

At step 2304, processor 102 receives an indication that the user has selected control 2404 using one of the input devices. In response, at step 2306, processor 102 selects one of the entries for the field.

The status of the selected entry is evaluated at step 2308 using the process of FIG. 17. After the entry status has been evaluated, the method determines if the entry status allows the entry to be approved at step 2312. When the entry status does not allow the entry to be approved, the entry is left unapproved at step 2310. When the entry status allows the entry to be approved, a value is stored for the entry indicating that the data for the entry or lack of data for the entry has been approved at step 2314.

At step 2316, the method determines if there are more entries for the agricultural field. If there are more entries, the method returns to step 2306 to select the next entry and steps 2308-2314 are repeated for the next entry. When all of the entries for the agricultural field have been processed, the method of FIG. 23 ends at step 2318.

Thus, the embodiments described above improve the technology associated with documenting agricultural production by allowing a grower to approve data for multiple pass entries with a single selection of a control instead of approving each pass entry individually.

After data has been provided for each pass of an agricultural field, the data provided for the field can be used to determine a sustainability value. The present embodiments may be used to calculate any desired sustainability value including carbon intensity scores such as Feed Stock Carbon Intensity scores.

A significate problem with existing technology associated with assigning a sustainability value to a crop is that the technology does not permit efficient auditing of the values used to compute the sustainability value. Such auditing is a requirement of any system that assigns a financial value to a sustainability value for a crop. Such systems quickly become unusable if an auditor is not able to quickly inspect the evidence that supports the values used to determine the sustainability value

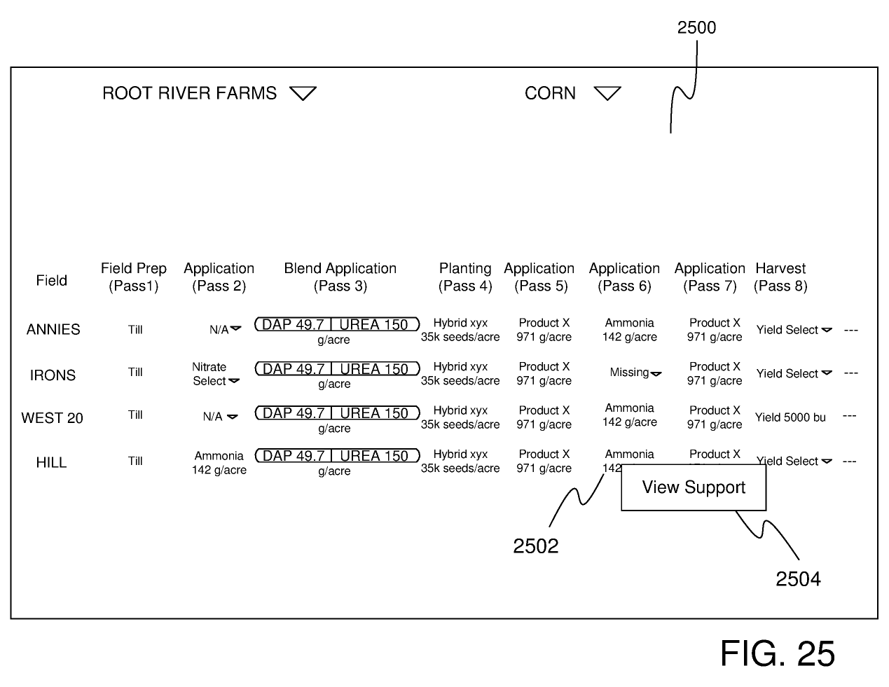

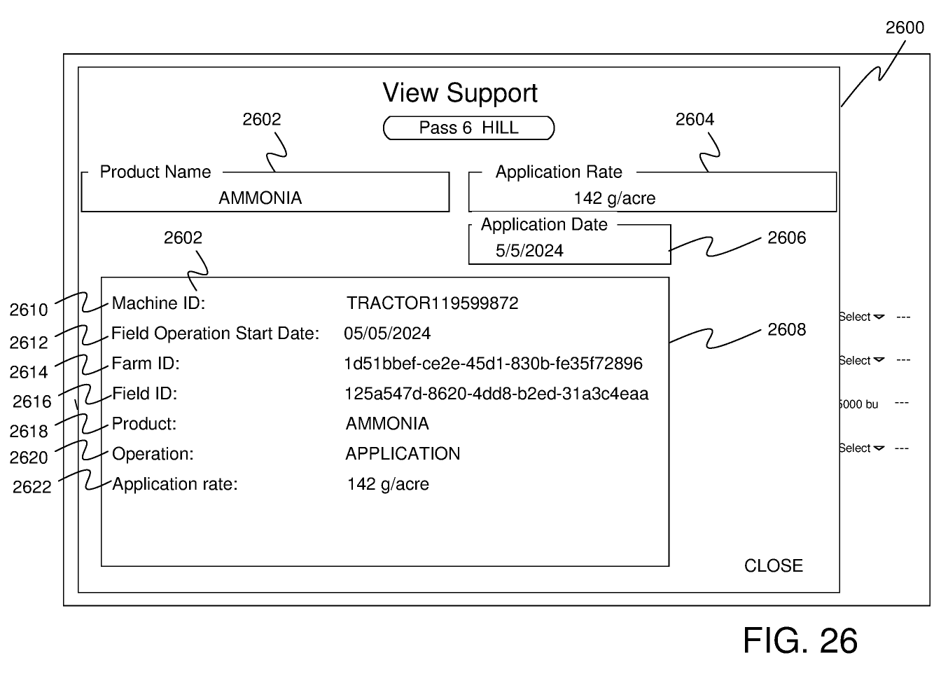

In accordance with several embodiments, once the data associated with an agricultural machine pass has been approved, processor 102 enables a “View Support” control that allows an auditor to view evidence supporting the data. For example, in user interface 2500 of FIG. 25, a “View Support” control 2504 is displayed after a user selects entry 2502, which has been approved. When a user selects control 2504, a “View Support” window is displayed such as window 2600 of FIG. 26.

The view support window includes a description of the product applied 2602, the application rate 2604 and the application date 2606. In addition, the view support window includes either an attestation from the grower and/or a receipt for the product applied or agricultural machine data generated by the agricultural machine that performed the pass. In FIG. 26, agricultural machine data 2608 is provided that includes a unique machine identifier 2610 for the machine that performed the pass, operation start date 2612, farm identifier 2614, field identifier 2616, product identifier 2618, operation 2620 and application rate 2622. In accordance with some embodiments, agricultural machine data 2608 may also include a hash value that can be used to ensure the data has not been altered since being sent by the machine.

In accordance with one embodiment, the data entered into the system for passes of a field are stored together with one or more sustainability scores calculated from the parameters in an immutable format such as a product transfer document. In accordance with some embodiment, evidence for each pass is included in the product transfer document.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
setting a data template for growing a crop, the data template comprising an ordered plurality of agricultural machine passes with each agricultural machine pass having an associated operation;
receiving a designation that an agricultural field will be used to grow the crop;
assigning the data template to the agricultural field based on the received designation to form a database structure for the agricultural field; and
using the database structure to display a user interface showing that the ordered plurality of agricultural machine passes has been designated for the agricultural field.

2. The method of claim 1 wherein the user interface shows that the ordered plurality agricultural machine passes has been designated for a plurality of fields, wherein each field in the plurality of fields has been designated to grow the crop.

3. The method of claim 2 wherein for each field of the plurality of fields, the user interface displays a respective pass entry for each of the plurality of agricultural machine passes and wherein each pass entry is selectable such that when selected a further user interface is provided to allow a user to enter parameters for the agricultural machine pass for one of the plurality of fields.

4. The method of claim 3 wherein the parameters comprise a product applied during the agricultural machine pass and a rate of application of the product during the agricultural machine pass.

5. The method of claim 1 further comprising:
receiving data from an agricultural machine, the data indicating a product applied during an agricultural machine pass; and
assigning the data to a pass entry.

6. The method of claim 5 further comprising providing a control to view the data received from the agricultural machine.

7. The method of claim 2 further comprising providing a control for a user to approve data for agricultural machine pass across the plurality of agricultural fields with a single selection of the control.

8. The method of claim 2 further comprising providing a control for a user to approve data for at least two agricultural machine passes for a field with a single selection of the control.

9. A method comprising:
displaying entries for a plurality of agricultural machine passes for a plurality of agricultural fields on a single screen;
providing a control that allows a user to approve data for a single agricultural machine pass for at least two of the plurality of agricultural fields;
receiving an indication that the user has invoked the control; and
in response, storing indications in a database that the data has been approved for the single agricultural machine pass for each of the at least two of the plurality of agricultural fields.

10. The method of claim 9 further comprising:
providing a second control that allows a user to approve data for at least two agricultural machine passes of the plurality of agricultural machine passes for a single agricultural field;
receiving an indicating that the user has invoked the second control; and
in response, storing indications in a database that data has been approved for the at least two agricultural machine passes for the single agricultural field.

11. The method of claim 9 wherein the plurality of agricultural machine passes are assigned to the plurality of agricultural fields through a template defined for a crop grown on the agricultural field.

12. The method of claim 9 wherein the data for the single agricultural machine pass for the at least two of the plurality of agricultural fields was received from an agricultural machine that performed the agricultural machine pass.

13. The method of claim 12 further comprising providing a control to view the data received from the agricultural machine.

14. The method of claim 9 wherein for at least one of the plurality of agricultural fields, two values have been entered for the agricultural machine pass and in response to the user invoking the control, an error message is presented requiring that the user select one of the two values for the agricultural field.

15. The method of claim 9 wherein for at least one of the plurality of agricultural fields, no value has been entered for the agricultural machine pass and in response to the user invoking the control, an error message is presented requiring that the user to either provide a value or indicate that no value will be provided.

16. A method comprising:
displaying parameters for a plurality of agricultural machine passes for each of a plurality of agricultural fields on a single screen;
providing a control in association with a displayed parameter to view evidence for the parameter.

17. The method of claim 16 further comprising:
providing a control for approving data for an agricultural machine pass for at least two of the plurality of displayed agricultural fields.

18. The method of claim 16 further comprising:
providing a control for approving data for at least two of the plurality of agricultural machine passes of a single agricultural field of the plurality of agricultural fields.

19. The method of claim 16 wherein the plurality of agricultural machine passes are set as a template by a grower for all fields owned by the grower that grow a particular crop.

20. The method of claim 16 wherein the evidence comprises data provided by the agricultural machine that performed the pass.
